(19) United States
(12) Patent Application Publication
(10) Pub. No.: US 2018/0094132 A1
(43) Pub. Date: Apr. 5, 2018

(54) POLYGLYCOLIC ACID RESIN COMPOSITION, MOLDED PRODUCT FOR WELL DRILLING, AND DOWNHOLE TOOL MEMBER

(71) Applicant: Kureha Corporation, Tokyo (JP)

(72) Inventors: Takuma Kobayashi, Tokyo (JP); Hikaru Saijo, Tokyo (JP); Katsumi Yoshida, Tokyo (JP)

(73) Assignee: Kureha Corporation, Tokyo (JP)

(21) Appl. No.: 15/831,958

(22) Filed: Dec. 5, 2017

Related U.S. Application Data
(62) Division of application No. 15/520,492, filed on Apr. 20, 2017.

(30) Foreign Application Priority Data
Nov. 13, 2014 (JP) 2014-230420

(51) Int. Cl. C08L 67/04; C08L 33/10; B22C 1/22; C08G 63/06; E21B 4/16

(52) U.S. Cl. CPC C08L 67/04; C08L 33/10; E21B 4/16; C08G 63/06; B22C 1/2266

(57) ABSTRACT

In light of increasingly severe and diverse excavation conditions for hydrocarbon resource recovery, such as the drilling of very deep wells, provided is a highly impact-resistant polyglycolic acid resin composition that is resistant to damage even from contact or collision with various members during molding, transport, and well drilling; has excellent mechanical properties and heat resistance; can easily be removed as necessary after the completion of well treatment; and contributes to reducing the cost and shortening the process of well drilling. Also, provided is a molded product for well drilling, such as a downhole tool member.

### CROSS REFERENCE TO RELATED APPLICATIONS

This application is a Divisional of copending application Ser. No. 15/520,492, filed on Apr. 20, 2017, which was filed as PCT International Application No. PCT/JP2015/081848 on Nov. 12, 2015, which claims priority under 35 U.S.C. § 119(a) to Patent Application No. 2014-230420, filed in Japan on Nov. 13, 2014, all of which are hereby expressly incorporated by reference into the present application.

### TECHNICAL FIELD

The present invention relates to a polyglycolic acid resin composition for use in a downhole tool member or the like, to produce hydrocarbon resources such as petroleum or natural gas and recover hydrocarbons; a molded product for well drilling; a downhole tool member; and a well drilling method.

### BACKGROUND ART

Hydrocarbon resources, such as petroleum or natural gas, have been produced by excavating wells (oil wells or gas wells, sometimes collectively called “wells”) that have a porous and permeable subterranean formation. As energy consumption increases, deeper wells are being drilled, with some being recorded to reach depths greater than 9000 m worldwide, and with some deep wells in Japan being greater than 6000 m. In wells that are continuing to be drilled, the productive layer is stimulated in order to continuously drill hydrocarbon resources efficiently from subterranean formations the permeability of which has decreased over time, or from subterranean formations of which the permeability was not sufficient to begin with. Acid treatment and fracturing are known stimulation methods (Patent Document 1). Acid treatment is a method in which the permeability of the productive layer is increased by injecting an acid such as hydrochloric acid or hydrofluoric acid into the productive layer and dissolving the reaction components of bedrock (carbonates, clay minerals, silicates, and the like). However, various problems that accompany the use of strong acids have been identified, and increased costs, including various countermeasures, have also been pointed out. Thus, perforation for forming pores and hydraulic fracturing for forming fractures in the productive layer using fluid pressure have received attention.

Hydraulic fracturing is a method in which perforations or fractures are generated in the productive layer by fluid pressure such as water pressure (also simply called “hydraulic pressure” hereinafter). Generally, a vertical hole is drilled, and then the vertical hole is curved and a horizontal hole is drilled in a subterranean formation several thousand meters underground. A fluid such as fracturing fluid (in most cases, a water-based fluid containing various additives as needed, such as proppants, channelants, gelling agents, scale inhibitors, acids, friction reducing agents, and the like) is then fed at high pressure into these boreholes (meaning holes provided for forming a well, also called “downholes”), and fractures and the like are produced by the hydraulic pressure in the deep subterranean productive layer (a layer that produces a hydrocarbon resource such as petroleum or natural gas), thereby stimulating the productive layer in order to extract and recover the hydrocarbon resource through the fractures and the like. The efficacy of hydraulic fracturing has also been examined for the development of unconventional resources such as so-called shale oil (oil that matures in shale) and shale gas.

The following method is typically used to produce fractures and perforations by hydraulic pressure in the productive layer of a deep subterranean formation (layer that produces the hydrocarbon resource, including a petroleum such as shale oil, and natural gas such as shale gas) using fluid fed at high pressure. Specifically, while subjecting a borehole (downhole) that has been drilled into a subterranean formation several thousand meters deep to plugging (also called “sealing”) in sequential fashion from the top end of the borehole, a prescribed section is partially plugged, and a fluid is injected at high pressure into the plugged section to create fractures and perforations in the productive layer. Then, the next prescribed section (typically ahead of the preceding section, i.e., a segment closer to the ground surface) is plugged to produce fractures and perforations. After that, this process is repeated until the required isolation and formation of fractures and perforations have been completed.

Stimulation of the productive layer is not limited to new wells, but is sometimes repeated for desired sections of boreholes that have already been formed. In such cases as well, operations such as plugging of the borehole, fracturing with a high-pressure fluid, and the like may be similarly repeated. Additionally, there are also cases where, to perform finishing of the well, the borehole is plugged to plug fluid from below, and after finishing of the top portions thereof is performed, the plug is released. Various types of tools for performing desired operations are used inside newly formed boreholes and previously formed boreholes, and these tools are referred to collectively as “downhole tools.” In a broad sense, the general concept of downhole tools may include drilling equipment and power sources therefor, sensors and communication devices for acquisition and exchange of the locations of various tools and drilling information; representative examples include plugs (also called frac plugs, bridge plugs, packers, and the like) which are used for plugging or fixation of boreholes.

For example, Patent Document 2 discloses a plug for well drilling (also simply called “downhole plug” hereinafter). Specifically, there is disclosed a plug including a mandrel (main body) having a hollow part in the axial direction; a ring or annular member extending in the axial direction on the outer circumferential surface orthogonal to the axial direction of the mandrel; a first conical member and slip; a malleable element formed from elastomer, rubber, or the like; a second conical member and slip; and an anti-rotation feature. Closing off a borehole with this plug for well drilling is performed as follows. Specifically, by moving the mandrel in the axial direction thereof, the gap between the ring or annular member and the anti-rotation feature shrinks, in association with which the slip abuts against the sloping face of the conical member (in the industry, this is sometimes called a “wedge”), and advances along the conical member, thereby expanding radially outward and abutting against the inside wall of the borehole to become fixed in the borehole, while the malleable element deforms by diametric expansion to close off and seal the space between the mandrel and the inside wall of the borehole. The mandrel has a hollow part in the axial direction, and the borehole can be closed off by setting a ball (also called a “ball sealer”) therein. As materials for forming plugs (each of which materials is included in the concept of downhole tool members), there have been disclosed a wide range of exemplary materials such as metal materials (aluminum, steel, stainless steel, and the like), fibers, wood, composite materials, or plastics, the preferred materials being composite materials containing a reinforcing material such as carbon fibers, and particular polymer composite materials of epoxy resin, phenolic resin, and the like, while the mandrel is formed from aluminum or a composite material. On the other hand, with regard to balls, it is disclosed that, besides the previously described materials, materials that degrade due to temperature, pressure, pH (acidic, basic), or the like can be used.

Further, Patent Document 3 discloses a disposable type downhole tool or a component thereof, that contains a biodegradable material that decomposes when exposed to the environment inside a well, and discloses the use of a degradable polymer, such as polylactic acids or other such aliphatic polyesters, as the biodegradable material. Patent Document 3 further discloses a combination of a tubular body element having a flow bore in the axial direction, a packer element assembly comprising an upper sealing element, a center sealing element, and a lower sealing element along the axial direction on the outer circumferential surface orthogonal to the axial direction of the tubular body element, a slip, and a mechanical slip body. Furthermore, Patent Document 3 discloses that fluid flow in only one direction is allowed due to the fact that a ball is set in the flow bore of the tubular body element.

Downhole tools such as plugs used in well drilling, and components thereof, i.e., mandrels, slips, wedges, rubber components, balls (ball sealers), ball seats, and other such downhole tool members, are arranged sequentially inside the well until the well is completed, but is required to be removed at the stage when production of petroleum, such as shale oil, or natural gas, such as shale gas (hereinafter collectively called “petroleum and natural gas” or “petroleum or natural gas”), begins. Because a downhole tool such as a plug, and a downhole tool member such as a ball (ball sealer), is typically not designed to be retrievable after use and unplugging, the tool or component is removed by being dismantled or reduced into small pieces by a method such as fracturing, drilling out, or other method, but substantial costs and time were needed for the fracturing or drill out procedure. There are also plugs specially designed to be retrievable after use (retrievable plugs), but since plugs are placed a deep subterranean formation, substantial cost and time are required to retrieve all of them.

It has been widely attempted to make improvements in the use of degradable materials as downhole tools or downhole tool members. Patent Document 4 discloses a degradable ball sealer (equivalent to a downhole tool or downhole tool member) for plugging a perforation within a casing that is disposed within a downhole. Specifically, Patent Document 4 discloses a ball sealer formed from a resin composition which contains a polyester, such as a polylactic acid or a lactic acid-glycolic acid copolymer, that is substantially insoluble in a well fluid, that decomposes to an oligomer in the presence of water at the temperature of the subterranean formation, and that is soluble in the fluid of the subterranean formation.

Further, Patent Document 5 discloses a composition for a ball, which decomposes, dissolves, exfoliates, or experiences marked degradation in another physical characteristic, over time in the presence of hydrocarbons and subterranean heat. More specifically, Patent Document 5 discloses a combination of a ball (equivalent to a downhole tool member) which is disposed within a sleeve slidable between a first position and a second position within a pipe, and which includes a material that decomposes at temperatures higher than 65.6° C. (equivalent to 150° F.) and a ball seat (equivalent to a downhole tool member) which has an opening smaller in diameter than the diameter of the ball; and discloses that the ball material that decomposes at temperatures higher than 65.6° C. is a composition containing a thermal-curing polymer, a thermoplastic polymer, an elastomer, and the like, and may further include aramid, glass, carbon, boron, polyester, cotton, or ceramic fibers or particles.

In the above manner, based on increasing demand to secure energy resources and protect the environment, and particularly given that extraction of non-conventional resources continues to expand, the excavation conditions are becoming increasingly harsh, such as increasingly greater depths and the like. Furthermore, increasingly diverse excavation conditions, such as the increasingly diverse temperature conditions that accompany increasing diverse depths, have created progressively more diversity in temperature, from lower than 60° C. to higher than 200° C. Specifically, various properties are required of materials for forming plugs such as frac plugs, bridge plugs, packers, and the like (downhole tools), balls (ball sealers), ball seats, or other downhole tool members, which properties include mechanical strength (tensile strength, compression elongation strength, impact strength, and the like) such that the member can be transported to a depth of several thousand meters underground; heat resistance, oil resistance, and water resistance such that mechanical strength and the like are maintained despite contact with a hydrocarbon resource targeted for recovery from an environment of high temperature and high humidity in a deep subterranean downhole; and seal performance or mechanical strength such that plugging can be maintained by high hydraulic pressure when plugging a downhole to carry out perforation or fracturing. Additionally, when a well drilling operation to recover a hydrocarbon resource has reached the end stage, there is a need for tools and members to also be easily removable under the environmental condition of the well (as explained above, there are a diversity of environments in terms of temperature conditions associated with greater diversity of depth, and the like).

In addition, the downhole tool members having degradability (also called “degradable downhole tool members” hereinafter) constituting a degradable downhole tool, for which there currently exists a need to develop practical versions thereof, may collide or contact with well wall surfaces or other various members, depending on the service environment, because the downhole tool and downhole tool members are used in a well drilling process under diverse environments involving great depths and the like, and other various members formed from various materials, including metals, are used within downholes. It was found that fracture, breakage, fragmentation or the like of degradable downhole tool members sometimes occurred due to the impact of contact or a collision, thus posing a risk that, for example, the desired sealing performance could not be produced or maintained. For this reason, depending on the service environment and the type of tool, there exists a need for degradable downhole tool members having high degrees of impact strength, i.e., impact-resistance, and a need has arisen for resin compositions having both biodegradability and excellent mechanical properties, such as impact-resistance, as materials for forming such downhole tool members.

In cases in which a degradable downhole tool member such as a mandrel, ball (ball sealer), ball seat or the like is formed from a degradable resin composition, in many cases, the member will be a molded product for well drilling formed by an extrusion molding process such as solidification- and extrusion-molding, or a melt extrusion process such as injection molding, or a molded product for well drilling which is a molded product of desired shape (also called a secondarily molded product) obtained by subjecting such a molded product (also called a primary molded product) to cutting, hole drilling, shearing, or other mechanical working process. Consequently, there exists a need for a degradable resin composition for forming a molded product for well drilling such as downhole tool members, i.e., a degradable, well drilling resin composition, having impact-resistance during molding processes, by way of compatibility with mechanical working such as cutting. Additionally, when molded products for well drilling such as downhole tool members are stored or transported, the molded products need to have impact-resistance (impact-resistance during transport) to resist fracturing due to contact or collision with various members.

Patent Document 6 discloses an aliphatic polyester resin composition having excellent impact-resistance and heat resistance. In Patent Document 6, the aliphatic polyester is not particularly limited, and numerous examples of polymers, including polymers having aliphatic hydroxycarboxylic acids as principal constituent components, and polymers having aliphatic polyhydric carboxylic acids and aliphatic polyhydric alcohols as principal constituent components, as well as numerous specific examples of the use of polylactic acid are disclosed. Patent Document 6 also discloses that such compositions can be widely employed as molded products of any shape, such as films, sheets, fibers/fabrics, nonwoven fabrics, injection molded products, extrusion molded products, vacuum pressure molded products, blow molded products, or composites with other materials, for applications such as automotive materials, electric/electronic device materials, agricultural materials, horticultural materials, fishery materials, engineering and construction materials, stationary, medical products, and the like. However, Patent Document 6 contains no specific suggestion of the particular problems that pertain to the well drilling applications described above, or compositions for achieving solutions thereto.

Patent Document 7 discloses an aliphatic polyester resin composition having excellent impact-resistance. The aliphatic polyester resin composition of Patent Document 7 specifically contains (A) an aliphatic polyester comprising polylactic acid, and (B) a multilayer-structure polymer, the weight ratio (A)/(B) being 99/1 to 50/50. The multilayer-structure polymer (B) is composed of a polymer containing at least one type of unit selected from glycidyl group-containing vinyl units, or unsaturated dicarboxylic acid anhydride units. However, Patent Document 7 contains no specific suggestion of the particular problems that pertain to the well drilling applications described above, or compositions for achieving solutions thereto.

That is, as excavation conditions, such as greater depths, become increasingly harsher and more diverse, there has arisen a need for resin compositions, and for molded products for well drilling such as downhole tool members and the like, which have high impact-resistance to resist damage during molding processes or transport, or due to contact or collision with various members that are used in well drilling, which moreover have excellent mechanical properties and heat resistance, and which can be easily removed under various environmental conditions of wells if necessary, thus contributing to reductions in well drilling costs and shorter processes.

### CITATION LIST

### Patent Literature

Patent Document 1: Japanese Patent Publication “Japanese Unexamined Patent Application Publication (Translation of PCT Application) No. 2003-533619A (publication date Nov. 11, 2003)”
Patent Document 2: US Unexamined Patent Application Publication No. 2011/0277989
Patent Document 3: US Unexamined Patent Application Publication No. 2005/0205266
Patent Document 4: U.S. Pat. No. 4,716,964
Patent Document 5: US Unexamined Patent Application Publication No. 2012/0181032
Patent Document 6: Japanese Patent Publication “Japanese Unexamined Patent Application Publication No. 2003-286396A (publication date Oct. 10, 2003)”
Patent Document 7: Japanese Patent Publication “Japanese Unexamined Patent Application Publication No. 2011-26621A (publication date Feb. 10, 2011)”

### SUMMARY OF INVENTION

### Technical Problem

As excavation conditions, such as greater depths, become increasingly harsher and more diverse, an object of the present invention is to provide a polyglycolic acid resin composition which have high impact-resistance to resist damage during molding processes or transport, or due to contact or collision with various members during well drilling, which moreover have excellent mechanical properties and heat resistance, and which can be easily removed under various environmental conditions of wells if necessary, thus contributing to reductions in well drilling costs and shorter processes. A further object of the present invention is to provide a molded product for well drilling, in particular a downhole tool member, which is formed from the polyglycolic acid resin composition and which has excellent impact-resistance and the like, as well as a well drilling method that uses the molded product for well drilling.

### Solution to Problem

As a result of painstaking research directed to solving the problem, the inventors discovered that the problem can be solved by including a specific impact modifier to polyglycolic acid which is a degradable resin, to give a polyglycolic acid resin composition of excellent impact-resistance, mechanical properties, and heat resistance, and thereby completed the present invention.

Specifically, according to the present invention, there is provided a polyglycolic acid resin composition, comprising a polyglycolic acid; and an acrylic rubber core-shell polymer having an acrylic rubber as a core layer, and a vinyl (co)polymer as a shell layer. In the polyglycolic acid resin composition, a melt viscosity of the polyglycolic acid is from 450 to 1600 Pa·s when measured at a temperature of 270° C. and a shear rate of 122 sec⁻¹, and an average inter-particle distance of the acrylic rubber core-shell polymer dispersed in the polyglycolic acid is from 0.2 to 2.5 μm.

### Advantageous Effects of Invention

The present invention has the advantageous effect that, by employing a polyglycolic acid resin composition which contains polyglycolic acid, and an acrylic rubber core-shell polymer having an acrylic rubber as a core layer and a vinyl (co)polymer as a shell layer, there can be provided a polyglycolic acid resin composition which, despite harsh and diverse excavation conditions, such as greater depths, encountered in hydrocarbon resource recovery, has high impact-resistance to resist damage during molding processes or transport, or due to contact or collision with various members during well drilling, and which moreover has excellent mechanical properties and heat resistance, and can be easily removed after the end of the drilling process if necessary, thus contributing to reductions in well drilling costs and shorter processes.

### DESCRIPTION OF EMBODIMENTS

A resin composition for well drilling according to an embodiment of the polyglycolic acid resin composition of the present invention shall be described in specific terms below. The polyglycolic acid resin composition of the present invention is not limited to the composition for well drilling described below.

### I. Resin Composition for Well Drilling

The resin composition for well drilling according to one embodiment of the present invention is a resin composition for well drilling characterized by containing polyglycolic acid as the main component, and an acrylic rubber core-shell polymer having an acrylic rubber as a core layer and a vinyl (co)polymer as a shell layer.

### 1. Polyglycolic Acid

The polyglycolic acid (sometimes called “PGA” hereinafter) contained in the resin composition for well drilling according to the present embodiment is a polymer that contains repeating units represented by Formula 1 —(—O—CH₂—CO—)—. The proportion of the repeating units represented by Formula 1 in the polymer is typically 50 mass % or greater, preferably 70 mass % or greater, more preferably 80 mass % or greater, even more preferably 90 mass % or greater, particularly preferably 95 mass % or greater, and most preferably 99 mass % or greater. If the proportion of the repeating units represented by Formula 1 is less than 50 mass %, toughness, heat resistance, mechanical properties, crystallinity, gas barrier properties, and the like tend to be lower. In many cases, use of homopolymer of polyglycolic acid, in which the proportion of repeating units represented by Formula 1 is 100 mass %, is the most preferable.

The PGA can be produced by condensation polymerization of glycolic acid, or ring-opening polymerization of glycolide. Preferable repeating units besides the repeating units represented by Formula 1 include, for example, repeating units derived from cyclic monomers such as ethylene oxalate, lactide, lactones, trimethylene carbonate, and 1,3-dioxane; however, the repeating units are not limited to these. Even more preferable repeating units besides the repeating units represented by Formula 1 are lactic acid repeating units, and as a glycolic acid/lactic acid copolymer (sometimes called “PGLA” hereinafter) obtained therefrom, there can be used a copolymer in which the proportion (mass ratio) of glycolic acid repeating units and lactic acid repeating units is 99:1 to 50:50, preferably 99:1 to 70:30, and more preferably 99:1 to 80:20.

By introducing the cyclic monomer-derived repeating units in a proportion of 1 mass % or greater, the processing temperature of the PGA can be lowered, whereby thermal decomposition during melt processing can be reduced. Extrusion moldability can be also enhanced by controlling the rate of crystallization of the PGA, through copolymerization. On the other hand, if too many repeating units are derived from the cyclic monomer, there is a risk of severely diminishing the impact-resistance and heat resistance of the molded product for well drilling, which is a molded downhole tool member or the like.

The PGA used in the present invention is preferably a high-molecular weight polymer. The melt viscosity of the PGA, measured at a temperature of 270° C. and a shear rate of 122 sec⁻¹, is from 200 to 2000 Pa·s, preferably from 450 to 1600 Pa·s, more preferably from 700 to 1400 Pa·s, particularly preferably from 850 to 1300 Pa·s, and most preferably from 910 to 1200 Pa·s. Thus, to accord with the melt viscosity range in question, the weight average molecular weight (Mw) of the PGA used in the present invention is from 147000 to 270000, preferably from 177000 to 248000, more preferably from 199000 to 240000, particularly preferably from 212000 to 236000, and most preferably from 217000 to 232000. If the melt viscosity of the PGA is too low, it becomes difficult to achieve consistent molding through melt molding or the like, the impact-resistance, heat resistance, or other properties of the molded product for well drilling obtained therefrom may be lower, and cracking will tend to occur during the molding process, such as a mechanical process for forming a downhole tool member or the like, for example. Additionally, if the melt viscosity of the PGA is too low, cracking may occur when the molded product for well drilling undergoes heat treatment (annealing). Additionally, in cases of excessively low melt viscosity of the PGA, the difference in the melt viscosity between the PGA and the acrylic rubber core-shell polymer will be quite large, which may make it hard for shear force to be applied to the acrylic rubber core-shell polymer, resulting in poor dispersibility (lowered impact strength). On the other hand, if the melt viscosity of the PGA is too high, thermal degradation of the PGA will easily occur, because the PGA will have to be heated to a high temperature during melt molding. Additionally, if the melt viscosity of the PGA is too high, it may occur, for example, that the axle of the processing machine breaks during mechanical working as described above.

The resin composition for well drilling according to the present embodiment is a resin composition that contains PGA as the main component. “Main component” means that the contained proportion of PGA in the resin component contained in the composition is typically at least 50 mass %, preferably at least 70 mass %, more preferably at least 80 mass %, and even more preferably at least 90 mass %. Examples of other resin components include thermoplastic resins other than PGA, such as polylactic acid (sometimes called “PLA” hereinafter), and other biodegradable resins. A resin composition in which the contained proportion of PGA in the resin component is 100 mass % would also be acceptable. Examples of the PLA include homopolymers of L-lactic acid or D-lactic acid, or a stereocomplex polylactic acid, which is obtained by mixing poly-L-lactic acid and poly-D-lactic acid so that their respective molecular chains appropriately entangle to form a stereocomplex, and which is known to have high heat resistance. Also included are copolymers having 50 mass % or greater, preferably 75 mass % or greater, more preferably 85 mass % or greater, and even more preferably 90 mass % or greater of the L-lactic acid or D-lactic acid repeating units.

The PGA content in the resin composition for well drilling according to the present embodiment can be decided, as appropriate, in consideration of the impact-resistance, heat resistance, and mechanical properties required of a downhole tool member or other molded product for well drilling to be formed from the composition, and of the ease of removal thereof after a well drilling operation if necessary, but where the total of the PGA and the acrylic rubber core-shell polymer having an acrylic rubber as a core layer and a vinyl (co)polymer as a shell layer, discussed below, equals 100 mass %, the PGA content is preferably from 60 to 98 mass %, more preferably from 62 to 97 mass %, and even more preferably from 65 to 96 mass %, and depending on the combination of the acrylic rubber core-shell polymer and a glycidyl methacrylate ethylene copolymer, discussed below, is from 48 to 98 mass %, and in some cases from 52 to 96 mass %.

### 2. Acrylic Rubber Core-Shell Polymer

The resin composition for well drilling according to the present embodiment is characterized by containing PGA, together with an acrylic rubber core-shell polymer having an acrylic rubber as a core layer and a vinyl (co)polymer as a shell layer (sometimes called an “acrylic rubber core-shell polymer” hereinafter), as an impact modifier. The resin composition for well drilling according to the present embodiment, by virtue of containing the acrylic rubber core-shell polymer impact modifier in addition to the PGA degradable resin, has high impact-resistance, as well as excellent mechanical properties and heat resistance, and is moreover easily removed after the end of a well drilling operation if necessary, and as a result can be used for forming a downhole tool member or other molded product for well drilling having high impact-resistance to resist damage during molding processes or transport, or due to contact or collision with various members that are used in well drilling.

### Average Inter-Particle Distance

In the resin composition for well drilling according to the present embodiment, the average inter-particle distance of the acrylic rubber core-shell polymer dispersed in the PGA is from 0.2 to 2.5 μm. The average inter-particle distance is equal to or greater than the average particle size of the acrylic rubber core-shell polymer. In particular, the average inter-particle distance is preferably from 0.3 to 2.3 μm, more preferably from 0.4 to 1.9 μm, particularly preferably from 0.5 to 1.8 μm, and most preferably from 0.7 to 1.6 μm. An advantage of setting the average inter-particle distance according to the present embodiment so as to satisfy the range in question is that impact force applied to the resin composition for well drilling will be effectively absorbed by the uniformly dispersed acrylic rubber core-shell polymer, with the result that very high impact-resistance can be achieved. In the present embodiment, the average inter-particle distance can be obtained, for example, by observing the resin composition for well drilling with a scanning electron microscope, measuring the distances between centroids of nearby acrylic rubber core-shell polymer particles in the PGA.

### 2-1. Core-Shell Polymer

The acrylic rubber core-shell polymer contained in the resin composition for well drilling according to the present embodiment has a core-shell multilayer structure constituted by a core layer (innermost layer) and one or more layers (shell layers) covering this layer. There are no particular limitations as to the number of layers that make up the core-shell polymer as long as two or more layers are present; and may be three or more layers, or four or more layers. In the acrylic rubber core-shell polymer according to the present embodiment, the shell layer that includes at least the outermost layer preferably comprises a vinyl (co)polymer. Typically, the core layer and the shell layer are linked by graft linkages.

### 2-2. Acrylic Rubber Core Layer

The acrylic rubber core-shell polymer according to the present embodiment has acrylic rubber as the core layer. The acrylic rubber is a rubber (also called an “elastomer”) obtained by polymerizing an acrylic ester, such as butyl acrylate, and a small amount of a crosslinkable and/or graft-forming monomer such as butylene diacrylate. In addition to butyl acrylate, examples of the aforementioned acrylic esters include methyl acrylate, ethyl acrylate, propyl acrylate, n-hexyl acrylate, n-octyl acrylate, and 2-ethylhexyl acrylate. Examples of crosslinkable and/or graft-forming monomers include vinyl compounds such as divinyl benzene, butylene diacrylate, butylene dimethacrylate, ethylene glycol diacrylate, ethylene glycol dimethacrylate, butylene glycol diacrylate, butylene glycol dimethacrylate, oligoethylene glycol diacrylate, trimethylol propane diacrylate, trimethylol propane dimethacrylate, and trimethylol propane trimethacrylate; and allyl compounds such as allyl acrylate, allyl methacrylate, diallyl maleate, diallyl fumarate, diallyl itaconate, monoallyl maleate, monoallyl fumarate, and triallyl cyanurate, and divinyl benzene, butylene diacrylate, allyl acrylate, and the like are particularly preferable.

Further, in cases where particularly high heat resistance or the like is not required, the acrylic rubber of the acrylic rubber core-shell polymer according to the present embodiment may be a silicone acrylic rubber. Examples of silicone acrylic rubbers include polyorganosiloxane/acrylic composite rubbers or the like containing a silicone rubber component, such as a polyorganosiloxane rubber, and a component comprising the acrylic rubber described above. Examples of organosiloxanes for forming the polyorganosiloxane rubber include hexamethylcyclotrisiloxane, octamethylcyclotetrasiloxane, decamethylcyclopentasiloxane, dodecamethylcyclohexaisiloxane, trimethyltriphenylcyclotrisiloxane, tetramethyltetraphenylcyclotetrasiloxane, octaphenylcyclotetrasiloxane, and the like. The content of the silicone rubber component of the silicone acrylic rubber is typically from 0.1 to 50 mass %, and preferably from 0.2 to 30 mass %.

Further, the acrylic rubber in the acrylic rubber core-shell polymer according to the present embodiment may be one that contains a conjugated diene component such as butadiene, but from the perspective of heat resistance and the like, the conjugated diene component is preferably 30 mass % or less, and more preferably 20 mass % or less. If the conjugated diene component exceeds 30 mass %, in some instances, the heat resistance of the resin composition for well drilling will be poor. Optionally, the acrylic rubber can contain a styrene, acrylonitrile, or isoprene component.

### 2-3. Vinyl (Co)Polymer Shell Layer

The acrylic rubber core-shell polymer according to the present embodiment has a shell layer of a vinyl (co)polymer (as described previously, the shell layer that includes at least the outermost layer preferably comprises a vinyl copolymer). A vinyl (co)polymer refers to a homopolymer or copolymer of vinyl monomers that have vinyl groups. It is preferable for the vinyl (co)polymer that forms the shell layer to be a polymer having a higher glass transition temperature than the acrylic rubber that forms the core layer.

### Vinyl Monomer

There are no particular limitations as to the vinyl monomer that forms the vinyl (co)polymer contained in the shell layer of the acrylic rubber core-shell polymer according to the present embodiment, and examples thereof include unsaturated carboxylic acid alkyl ester monomers, unsaturated dicarboxylic acid anhydride monomers, unsaturated tricarboxylic acid anhydride monomers, aliphatic vinyl monomers, aromatic vinyl monomers, vinyl cyanide monomers, maleimide monomers, unsaturated monocarboxylic acid monomers, unsaturated dicarboxylic acid monomers, and unsaturated tricarboxylic acid monomers, and unsaturated carboxylic acid alkyl ester monomers or unsaturated dicarboxylic acid anhydride monomers is preferable from the perspective of impact-resistance and the like. One type of vinyl monomer may be used alone, or two or more types of vinyl monomer may be used in combination.

A (meth)acrylic acid alkyl ester is preferred for use as the unsaturated carboxylic acid alkyl ester monomer (“(meth)acrylic acid” or “(meth)acrylate” are respective terms well known to persons skilled in the art for “acrylic acid” or “methacrylic acid”, and “acrylate” or “methacrylate”, respectively). Specific examples include methyl (meth)acrylate, ethyl (meth)acrylate, n-propyl (meth)acrylate, n-butyl (meth)acrylate, t-butyl (meth)acrylate, n-hexyl (meth)acrylate, n-octyl (meth)acrylate, 2-ethylhexyl (meth)acrylate, cyclohexyl (meth)acrylate, stearyl (meth)acrylate, octadecyl (meth)acrylate, phenyl (meth)acrylate, benzyl (meth)acrylate, chloromethyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate, 2,3,4,5-tetrahydroxypentyl (meth)acrylate, aminoethyl acrylate, aminoethyl propyl acrylate, dimethylaminoethyl methacrylate, aminopropyl ethyl acrylate, aminoethyl phenyl methacrylate, or aminoethyl cyclohexyl methacrylate, and methyl (meth)acrylate, ethyl (meth)acrylate, n-butyl (meth)acrylate, and the like are preferred. When the acrylic rubber core-shell polymer in the present embodiment is one containing an unsaturated carboxylic acid alkyl ester monomer, such as methyl methacrylate, as the vinyl monomer forming the vinyl (co)polymer contained in the shell layer, the contained proportion of the unsaturated carboxylic acid alkyl ester monomer is typically from 80 to 100 mass % and preferably from 90 to 100 mass % with respect to the total amount of the vinyl monomer, although there is no particular limitation thereof.

Examples of unsaturated dicarboxylic acid include maleic anhydride, itaconic anhydride, glutaconic anhydride, citraconic anhydride, and the like. Examples of an unsaturated tricarboxylic acid anhydride monomer include aconitic anhydride and the like. Examples of aliphatic vinyl monomers include ethylene, propylene, or butadiene and the like. Examples of as aromatic vinyl monomers include styrene, α-methylstyrene, 1-vinylnapthalene, 4-methylstyrene, 4-propylstyrene, 4-cyclohexylstyrene, 4-dodecylstyrene, 2-ethyl-4-benzylstyrene, 4-(phenylbutyl)styrene, or halogenated styrene and the like. Examples of vinyl cyanide monomers include acrylonitrile, methacrylonitrile, or ethacrylonitrile and the like. Examples of maleimide monomers include maleimide, N-methylmaleimide, N-ethylmaleimide, N-propylmaleimide, N-isopropylmaleimide, N-cyclohexylmaleimide, N-phenylmaleimide, N-(p-bromophenyl)maleimide, or N-(chlorophenyl)maleimide and the like. Examples of unsaturated monocarboxylic acid monomers include (meth)acrylic acid, oleic acid, or ricinoleic acid and the like. Examples of unsaturated dicarboxylic acid monomers include maleic acid, monoethyl maleate, itaconic acid, phthalic acid, and the like. Examples of unsaturated tricarboxylic acid monomers include aconitic acid and the like.

Examples of yet other vinyl monomers include vinyl acetate, acrylamide, methacrylamide, N-methyl acrylamide, butoxymethyl acrylamide, N-propyl methacrylamide, N-vinyl diethylamine, N-acetyl vinylamine, allylamine, methallylamine, N-methyl allylamine, p-aminostyrene, 2-isopropenyl-oxazoline, 2-vinyl-oxazoline, 2-acryloyl-oxazoline, 2-styryl-oxazoline, 1-vinylcarbodiimide, or 1-phenyl-3-(1-phenylvinyl)carbodiimide and the like. If needed, the crosslinkable and/or graft-forming monomers described previously can be used as well.

### Vinyl Monomers Having Epoxy Groups

From the perspective of a balance between high impact-resistance and high heat resistance, it is particularly preferable for the vinyl (co)polymer contained in the shell layer of the acrylic rubber core-shell polymer of the present embodiment to contain a vinyl monomer having epoxy groups, as the vinyl monomer for forming the vinyl (co)polymer. Specifically, it is preferable for the resin composition for well drilling according to the present embodiment to be a resin composition for well drilling that contains PGA, and an acrylic rubber core-shell polymer containing an acrylic rubber as the core layer, and a vinyl (co)polymer formed from a vinyl monomer that contains a vinyl monomer having epoxy groups (sometimes called an “epoxy group-having vinyl (co)polymer” hereinafter) as the shell layer. There are no particular limitations as to the vinyl monomer having epoxy groups, and it would be preferable to use, for example, an α,β-unsaturated carboxylic acid epoxy ester (also called a “glycidyl ester”) or ether compound (also called a “glycidyl ether”). Specifically, examples include glycidyl acrylate, glycidyl methacrylate, glycidyl itaconate, diglycidyl itaconate, glycidyl oleate, glycidyl ricinoleate, allyl glycidyl ether, styrene-4-glycidyl ether, 4-glycidyl styrene, and the like, and it would be preferable to use glycidyl methacrylate as the vinyl monomer having epoxy groups. In the present embodiment, it is preferable to use any vinyl monomer having epoxy groups, regardless of the method of introduction or the introduced amount of epoxy groups (also called “glycidyl groups”). One type of vinyl monomer having epoxy groups may be used alone, or two or more types may be used. When the acrylic rubber core-shell polymer in the present embodiment contains a vinyl monomer having epoxy groups as the vinyl monomer forming the vinyl (co)polymer contained in the shell layer, while there is no particular limitation as to the contained proportion of the vinyl monomer having epoxy groups, the contained proportion is typically from 0.1 to 30 mass % and preferably from 1 to 15 mass % with respect to the total amount of the vinyl monomer.

### 2-4. Acrylic Rubber Core-Shell Polymer

From the perspective of further improving the impact-resistance of molded products obtained therefrom, the acrylic rubber core-shell polymer according to the present embodiment preferably has an average particle size (primary particle size) of 0.05 to 1 μm, more preferably of 0.1 to 0.8 μm, and even more preferably of 0.2 to 0.6 μm. The average particle size of the core-shell polymer refers to the particle size of the 50% percentile of the cumulative distribution, as measured by a laser diffraction method. While there are no particular limitations as to the mass ratio of the core layer and the shell layer in the core-shell polymer, the core layer is preferably from 50 to 95 mass %, more preferably from 55 to 93 mass %, and even more preferably from 60 to 90 mass %, with respect to the total core-shell polymer.

The acrylic rubber core-shell polymer in the resin composition for well drilling according to the present embodiment can itself be fabricated by known methods, but commercially available products are acceptable as well. Examples of commercially available products include, “PARALOID (trade name) EXL-2314”, manufactured by Rohm and Haas (core layer: acrylic rubber having butyl acrylate as the principal polymer component, shell layer: copolymer having as the principal polymer component methyl methacrylate into which epoxy groups have been introduced. Specifically, the product is equivalent to an acrylic rubber core-shell polymer containing acrylic rubber as the core layer, and an epoxy group-having vinyl (co)polymer as the shell layer), “PARALOID (trade name) EXL-2313” (core layer: acrylic rubber having butyl acrylate as the principal polymer component, shell layer: copolymer having methyl methacrylate as the principal polymer component, and “PARALOID (trade name) EXL-2315” (core layer: acrylic rubber having butyl acrylate as the principal polymer component, shell layer: copolymer having methyl methacrylate as the principal polymer component).

The content of the acrylic rubber core-shell polymer in the resin composition for well drilling according to the present embodiment can be decided, as appropriate, in consideration of the impact-resistance, heat resistance, and mechanical properties required of a downhole tool member or other molded product for well drilling to be formed from the composition, and of the ease of removal thereof after a well drilling operation if necessary, but when the total of the PGA and the acrylic rubber core-shell polymer equals 100 mass %, the content of the acrylic rubber core-shell polymer is preferably from 2 to 40 mass %, more preferably from 3 to 38 mass %, and even more preferably from 4 to 35 mass %, and depending on the combination of the acrylic rubber core-shell polymer and a glycidyl methacrylate ethylene copolymer, discussed below, is from 1 to 40%, and in some cases from 3 to 35 mass %.

### 3. Other Blended Components

The resin composition for well drilling according to the present embodiment may contain various additives as other blended components within amount ranges not detrimental to achieving the object of the present embodiment, such as chain extenders, stabilizers, degradation promoting agents or degradation inhibitors, reinforcing materials, fillers, colorants such as pigments, plasticizers, nucleating agents, or the like, as well as other resin materials such as the other degradable resins described previously. Impact modifiers besides acrylic rubber core-shell polymers (sometimes called “other impact modifiers” hereinafter) may be contained as well. The content of other blended components can be determined, as appropriate, depending on their respective types, the intended object, and other factors. For example, for a resin composition for well drilling, by further including a chain extender, the molecular weight of the PGA, which is a degradable resin, is increased, and impact-resistance is improved in some instances. The resin compositions for well drilling can also further contain reinforcing agents, in which case the resin composition for well drilling forms a degradable resin composite material, and mechanical properties are improved in some instances. The impact-resistance may be improved by the resin compositions for well drilling containing other impact modifiers besides acrylic rubber core-shell polymers.

### Other Impact Modifiers

In the resin composition according to the present embodiment, there are no particular limitations as to other impact modifiers that can be used in conjunction with acrylic rubber core-shell polymers, provided that the impact-resistance of the resin composition for well drilling can be improved by doing so, and there is no adverse impact on the mechanical properties or heat resistance.

For example, examples of other impact modifiers include materials that have elasticity such as various rubber materials or elastomer materials, epoxy group-having vinyl (co)polymers, and the like. These also fall into the conceptual category of other resin materials. Specific examples of the aforementioned various rubber materials or elastomer materials include natural rubber, isoprene rubber, ethylene propylene rubber, butyl rubber, styrene butadiene rubber, acrylic rubber, aliphatic polyester rubber, chloroprene rubber, polyurethane rubber, and other natural rubbers or synthetic rubbers; thermoplastic olefin elastomers (ethylene-propylene copolymers, ethylene-vinyl acetate copolymers, and the like), thermoplastic polyester elastomers (aromatic polyester-aliphatic polyester block copolymers, polyester-polyether block copolymers, and the like), thermoplastic polyurethane elastomers, styrene-butadiene-styrene block copolymers, styrene-ethylene/butylene-styrene copolymers (SEBS), and other such styrene thermoplastic elastomers, and the like; and examples of degradable rubber materials or elastomer materials that are biodegradable, hydrolyzable, or can be chemically degraded by some other method include aliphatic polyester rubber, polyurethane rubber, natural rubber, isoprene rubber, and the like, as well as rubber materials or elastomer materials having functional groups that are hydrolyzable. Glycidyl methacrylate-ethylene copolymers may also be exemplified as the preferred epoxy group-having vinyl (co)polymers, because concomitant effect thereof with acrylic rubber core-shell polymers can be observed. The aforementioned glycidyl methacrylate-ethylene copolymers can be procured as commercially available products, such as BONDFAST (trade name) manufactured by Sumitomo Chemical Co., and copolymers containing glycidyl methacrylate in various proportions, as well as various ternary copolymers that contain vinyl acetate or methyl methacrylate as copolymer components are known. The resin composition for well drilling according to the present embodiment may be one containing a glycidyl methacrylate-ethylene copolymer preferably at a level of 0 to 25 parts by mass, more preferably of 0 to 20 parts by mass, and even more preferably of 1 to 10 parts by mass, with respect to a total of 100 parts by mass of PGA and the acrylic rubber core-shell polymer.

### Chain Extenders

Compounds that in the past were used as chain extenders for degradable resins such as PGA can be used as chain extenders herein, for example, oxazoline compounds, isocyanate compounds, carbodiimide compounds, carbodiimide-modified isocyanate compounds, fatty acid bisamide compounds, alkyl-substituted fatty acid monoamide compounds, mono- to tri-functional glycidyl-modified compounds having a triazine skeleton, epoxy compounds, acid anhydrides, oxazine compounds, ketene compounds, and the like, and these may be used singly or in combinations of two or more. From the perspective of being able to achieve high impact-resistance and improve the balance of mechanical properties and degradability, oxazoline compounds, such as 2,2′-m-phenylene-bis-(2-oxazoline) (also called 1,3-PBO: “2,2′-(1,3-phenylene)bis(2-oxazoline)”), and isocyanate compounds, such as xylylene diisocyanate (XDI), are preferred.

### Reinforcing Materials or Fillers

As reinforcing materials or fillers (hereinafter sometimes referred to collectively as “reinforcing materials”), there may be used materials such as resin materials used as reinforcing materials in the past with the objective of improving mechanical strength or heat resistance, and fibrous reinforcing materials, or particulate form or powder form reinforcing materials, may be used. These reinforcing materials may be used singly, or in combinations of two or more types. The reinforcing material may be treated with a sizing agent or surface treatment agent as needed.

Examples of fibrous reinforcing materials include inorganic fibrous substances such as glass fibers, carbon fibers, asbestos fibers, silica fibers, alumina fibers, zirconia fibers, boron nitride fibers, silicon nitride fibers, boron fibers, and potassium titanate fibers; metal fibrous substances such as stainless steel, aluminum, titanium, steel, and brass; high-strength, high elastic modulus fibers such as aramid fibers, PBO fibers, and ultra-high molecular weight polyethylene fibers; kenaf fibers; and organic fibrous substances with a high melting point such as polyamides, fluororesins, polyester, and acrylic resins; and the like. The fibrous reinforcing materials are typically short fibers having a length of not greater than 10 mm, more preferably from 1 to 6 mm, and even more preferably from 1.5 to 4 mm, the use of inorganic fibrous substances is preferred, and glass fibers are particularly preferred.

As the particulate form or powder form reinforcing materials, mica, silica, talc, alumina, kaolin, calcium sulfate, calcium carbonate, titanium oxide, ferrite, clay, glass powder, milled fiber, zinc oxide, nickel carbonate, iron oxide, quartz powder, magnesium carbonate, barium sulfate, and the like can be used. The particulate form or powder form reinforcing material will normally have a particle size of 0.01 to 1000 μm, preferably of 0.05 to 500 μm, and more preferably of 0.1 to 200 μm.

### Colorants

The resin composition for well drilling according to the present embodiment may contain a colorant such as a dye or pigment. Through the use of a colorant, a resin composition for well drilling of high-quality appearance easily machined by cutting or the like can be obtained. As the colorant, pigments are preferred for their excellent heat resistance. As pigments, pigments of various tones, such as yellow pigments, red pigments, white pigments, and black pigments, and which are used in the technical field of synthetic resins can be used. Among these pigments, carbon black is particularly preferable. Examples of the carbon black include acetylene black, oil furnace black, thermal black, channel black, and the like. In cases where the resin composition for well drilling according to the present embodiment contains a colorant, the colorant content, expressed on a total amount basis, is preferably from 0.001 to 5 mass %, more preferably from 0.01 to 3 mass %, and even more preferably from 0.05 to 2 mass %. The colorant can be melt-kneaded with the PGA, but a PGA composition (masterbatch) containing a high concentration of colorant could also be produced, and this masterbatch is then diluted with PGA to prepare a resin composition for well drilling having the desired concentration of colorant.

The resin composition for well drilling according to the present embodiment can further contain resin modifiers, zinc carbonate, nickel carbonate and other such die corrosion inhibitors, lubricants, ultraviolet absorbers, boron nitride and other nucleating agents, flame retardants, and the like, added as appropriate, and the content and method of blending them can be in accordance with the preceding description.

### 4. Preparation of Resin Composition for Well Drilling

The preparation method of the resin composition for well drilling according to the present embodiment may rely on a method for preparing an typical resin composition for well drilling, through preparation by mixing PGA, an acrylic rubber core-shell polymer, and any other blending components, such as impact modifiers, which are desired to be contained (in some instances referred to collectively as “compositional components”), mixing these all at once or in any number of increments, at normal temperature or under heating. It is acceptable to impart shear force during mixing, and some or all of the compositional components may be melt-mixed under heating. Preparation of a pellet form is also acceptable, in consideration of factors such as convenience in handling. From the perspective of imparting higher impact-resistance and the like to the resin composition for well drilling according to the present embodiment, it is preferable for the PGA and the acrylic rubber core-shell polymer to be in a uniformly dispersed state, and to this end it is desirable for the PGA and the acrylic rubber core-shell polymer to be kneaded under high shearing force. A twin-screw kneading extruder or the like can be used as the device for kneading under high shearing force.

### 5. Impact-Resistance, Mechanical Properties, and Heat Resistance of Resin Composition for Well Drilling

By virtue of containing the acrylic rubber core-shell polymer, the resin composition for well drilling according to the present embodiment has high impact-resistance, as well as excellent mechanical properties and heat resistance, as a result of which the composition is suited to forming molded products for well drilling, such as downhole tool members, that resist damage due to contact or collision with various members used in well drilling. Methods for measuring and methods for evaluating mechanical properties, including impact-resistance, and heat resistance, will be described below.

### Izod Impact Strength (Unnotched)

The resin composition for well drilling according to the present embodiment has high impact-resistance, and the Izod impact strength (unnotched), which is an indicator of impact-resistance, is 900 J/m or greater. The Izod impact strength (unnotched) is measured as follows for an unnotched test piece, in accordance with ASTM D256 (corresponding to ISO180). Specifically, the value refers to the Izod impact strength (average value of n=5, unit: J/m) calculated from measurements of impact energy absorbed at the time of breakage of an unnotched test piece, taken at normal temperature (a temperature of 23° C.±1° C.) and using a pendulum impact test machine (hammer mass 120 kg), wherein the test piece (unnotched) has a cuboid shape with a length of 63.5 mm, a width of 12.7 mm, and a thickness of 3.0 mm, and is prepared in accordance with the ASTM D256 standard. When the Izod impact strength (unnotched) of the resin composition for well drilling is less than 900 J/m, there is a risk that the impact-resistance will be insufficient, and that the downhole tool member may experience fracture, breakage, or fragmentation in cases of contact or collision with various members that are used in well drilling. Specifically, there is a risk, for example, 1) that a downhole tool member such as a ball may break, or a scratch (notch) may be produced, during movement at high speed; 2) that when a ball is in motion or a ball is being set in a ball seat (downhole tool member), and is impacted by another member or the like, the ball will break (at which time, if a notch has occurred as in 1), the member will be more susceptible to breakage as a result of the fact that the impact strength at this point constitutes notched impact strength, which is significantly lower than the unnotched impact strength); or 3) that during setting of a ball in a ball seat and application of pressure, the ball will fracture or break due to the pressure, owing to the presence of a scratch or fragmentation. From the perspective of preventing breakage during loading or the like at high speed, the Izod impact strength (unnotched) of the resin composition for well drilling according to the present embodiment is preferably 1000 J/m or greater, and more preferably 1100 J/m or greater, so as to be able to have very high impact-resistance. While there is no particular upper value as to the Izod impact strength (unnotched) of the resin composition for well drilling, the value is generally 4000 J/m or less, and no greater than about 10-fold that of a resin composition for well drilling that does not contain an acrylic rubber core-shell polymer. The Izod impact strength (unnotched) of the resin composition for well drilling according to the present embodiment has a magnitude which is at least 15-fold, preferably at least 17-fold, or depending on the composition, at least 18-fold, the magnitude of the Izod impact strength (notched), discussed below, and therefore, for example, a ball or other downhole tool member formed from the resin composition for well drilling is highly resistant to fracture, breakage, or fragmentation in cases of contact or collision with various members that are used in well drilling. While there is no upper limit as to this multiple of magnitude, the limit is normally 80-fold, and in most cases about 50-fold.

### Izod Impact Strength (Notched)

The Izod impact strength (average value of n=5, unit: J/m) of the resin composition for well drilling according to the present embodiment, calculated from a measurement of impact energy absorbed at the time of breakage of a notched test piece having the aforementioned shape in accordance with ASTM D256 standard, at normal temperature (a temperature of 23° C.±1° C.), using a pendulum impact test machine (hammer mass 40 kg) (sometimes called an “Izod impact strength (notched)” hereinafter) is preferably 50 J/m or greater, more preferably 55 J/m or greater, and even more preferably 60 J/m or greater. There is no particular upper limit to the Izod impact strength (notched), but the value is generally no greater than 400 J/m.

### Flexural Strength (Maximum Point Stress)

The resin composition for well drilling according to the present embodiment typically has flexural strength (maximum point stress) of 90 MPa or greater, and has exceptional mechanical properties, so as to be suited for use under harsh and diverse excavation conditions, such as great depth, during hydrocarbon resource recovery. The flexural strength (maximum point stress) of the resin composition for well drilling can be measured in accordance with JIS K7171. Specifically, the value (average value of n=5. Unit: MPa) is calculated for a test piece prepared according to the JIS K7171 standard (ASTM D790 test piece), from measurements of the maximum point stress when the test piece ruptured, taken from a stress-deflection curve obtained by carrying out bending tests at normal temperature (a temperature of 23° C.±1° C.). If the flexural strength (maximum point stress) of the resin composition for well drilling is less than 90 MPa, there is a risk that when a downhole tool or member thereof is positioned within a borehole in the high-temperature environment of a deep subterranean formation, and perforation or fracturing is carried out, the downhole tool or member may deform or fracture, or become broken or fragmented. From the perspective of expressing the aforementioned functions, the flexural strength (maximum point stress) of the resin composition for well drilling is preferably 95 MPa or greater, more preferably 100 MPa or greater, and even more preferably 105 MPa or greater, so that the mechanical properties can be very exceptional. While there is no particular upper limit as to the flexural strength (maximum point stress), the limit is generally 350 MPa or less.

### Heat Resistance

The resin composition for well drilling according to the present embodiment has exceptional heat resistance, and is suited for use under harsh and diverse excavation conditions, such as great depth, during hydrocarbon resource recovery. The heat resistance of the resin composition for well drilling can be verified by the following method. Specifically, an unnotched test piece formed from a resin composition for well drilling, prepared in accordance with the method described previously in the description of the Izod impact strength (unnotched) test method, is left to stand for a prescribed time (1 hour, 4 hours, and 8 hours) in an oven adjusted to a temperature of 170° C., after which time the Izod impact strength (unnotched) of the unnotched test piece is measured, and the maintenance rate (unit: %) with respect to the Izod impact strength (unnotched) of the unnotched test piece prior to being left to stand in the oven is calculated. When the maintenance rate after standing for 4 hours in the oven is 70% or greater, the heat resistance can be said to be good, and when the maintenance rate after standing for 8 hours in the oven is 70% or greater, the heat resistance can be said to be very good.

### II. Molded Products for Well Drilling

According to the present embodiment, there are provided molded products for well drilling which are formed from the resin composition for well drilling according to the present embodiment, wherein the molded products for well drilling have high impact-resistance, exceptional mechanical properties and heat resistance, and moreover can be easily removed after the end of a well drilling operation if necessary. Molded products for well drilling which are formed from the resin composition for well drilling according to the present embodiment can typically be formed by a melt molding process, such as extrusion molding, injection molding, compression molding (press molding), and the like. In the case of extrusion molding, solidification- and extrusion-molding may be employed in which the resin composition for well drilling is melted and extruded from a heated forming die, and while continuing to apply the high back pressure at the time of extrusion, cooled and hardened to prescribed shape within a cooling forming die. The shape and dimensions of the molded product for well drilling formed by melt molding according to the present embodiment may be selected according to the application, without any particular limitation. Examples of possible shapes include round bars having prescribed diameter, flat plates having prescribed thickness, and pipes having prescribed diameter and thickness, as well as those of heteromorphic cross sectional shape. With regard to dimensions, the diameter or thickness is typically 5 mm or greater, and if desired can be 10 mm or greater, 30 mm or greater, or 50 mm or greater, or depending on the application, 100 mm or greater or 120 mm or greater, or even 150 mm or greater in cases in which there is a particular need. While there is no upper limit as to diameter or thickness, typically the limit is 300 mm or less. Molded products for well drilling of the present embodiment in the unmodified round bar, flat plate, pipe, or heteromorphic cross sectional shape described above, or molded products for well drilling obtained by cutting or punching these to prescribed length, width and/or shape, can be used in well drilling methods. For example, a molded product for well drilling that constitutes a ball seat (e.g., of known shape such as an annular seat), a molded product for well drilling that constitutes a ring member, and the like may be used.

Molded Products for Well Drilling which are Secondarily Molded Products

Primary molded products constituted by the aforementioned molded products for well drilling formed by melt molding can be subjected to cutting, hole drilling, shearing, or other mechanical working process, optionally combined if needed, to obtain a secondarily molded product having a prescribed shape, which can also serve as a molded product for well drilling. Examples of cutting include turning, grinding, lathing, boring, and the like performed by using a single-bladed cutting tool. Examples of the cutting process methods that use multiple blades include milling, thread cutting, gear cutting, diesinking, filing, or the like, and hole-drilling processes may be included in some cases. Examples of shearing processes include shearing by a cutting tool (saw), shearing by abrasive grains, shearing by heating and melting, and the like. Additionally, a ground finish, a plastic working process such as scribed shearing or a punching process using a knife-shaped implement, or a specialty processing method such as laser beam machining, and the like may also be implemented. For example, in cases in which the molded product for well drilling (primary molded product) formed by melt molding is a molded product of thick-walled large flat plate or round bar shape, typically, the molded product may be sheared to appropriate dimensions or thickness, the sheared molded product may be ground to trim it to the desired shape, hole drilling processes may be performed at required locations, and finishing processes may be carried out if needed, to form a molded product for well drilling (secondarily molded product). However, the order of the machining processes is not limited to this. In cases in which, due to frictional heat produced during a machining process, it is difficult to produce a smooth surface due to melting of a solidification- and extrusion-molded degradable resin molded product constituting a machine-processed material, it is preferable for the machining process to be performed while cooling the cut surface or the like. When a primary molded product generates excessive heat due to frictional heat, this can cause deformation and discoloration, and therefore it is preferable to control the temperature of the primary molded product constituting a material for a machining process, or the processed surface thereof, to a temperature of 200° C. or lower, and more preferably to a temperature of 150° C. or lower.

There are no particular limitations as to the shape of a molded product for well drilling constituted by a secondarily molded product, provided it is one that can be formed by using a molded product for well drilling (primary molded product) formed from the resin composition for well drilling according to the present embodiment as a material for machine-processing and by machine-processing the material for machine-processing. For example, a molded product for well drilling (secondarily molded product) formed by a machining process of a round rod-shaped or tube shaped primary molded product, and having a shape suitable for a mandrel which is a downhole tool member, such as a rod-shaped body having an annular or non-annular step or protrusion, a rod-shaped body or tube-shaped body having an annular or non-annular recess, or a rod-shaped body or tube-shaped body having an annular or non-annular flange, can be formed. A molded product for well drilling (secondarily molded product) which is a ball, formed by a machining process of a primary molded product of round rod shape, can be formed. A molded product for well drilling (secondarily molded product) having an annular or non-annular flange and formed by a machining process of a primary molded product of pipe shape can be formed.

### Molded Product for Well Drilling as Downhole Tool Member

As described above, according to the present embodiment, there can be provided a molded product for well drilling which is a downhole tool member, and which is formed from the polyglycolic acid resin composition according to the present embodiment, and preferably formed directly or indirectly by melt molding. Examples of downhole tool members in the present embodiment include mandrels, slips, wedges, rings, and the like, which are known as members of downhole tools, namely, frac plugs or bridge plugs. Balls (ball sealers) and ball seats also fall under the category of downhole tool members. Consequently, according to the present embodiment, there are provided the aforementioned molded products for well drilling which are downhole tool members selected from the group consisting of balls, ball seats, mandrels, slips, wedges, and rings.

### III. Downhole Tool Members, Balls, Ball Seats, Mandrels, Slips, Wedges, or Rings

In light of the above, according to the present embodiment there are provided downhole tool members formed from the resin composition for well drilling according to the present embodiment, and in particular there are provided the downhole tool members selected from the group consisting of balls, ball seats, mandrels, slips, wedges, and rings, i.e., balls, ball seats, mandrels, slips, wedges, and rings formed from the resin composition for well drilling according to the present embodiment. The downhole tool members according to the present embodiment, or the aforementioned balls, ball seats, mandrels, slips, wedges, or rings, used under harsh and diverse excavation conditions, such as great depth, for hydrocarbon resource recovery, can have high impact-resistance to resist damage during molding processes or transport, or due to contact or collision with the well wall surface or with various members during well drilling, moreover have excellent mechanical properties and heat resistance, and can be easily removed after the end of the drilling operation if necessary, thus contributing to reductions in well drilling costs and to shorter processes.

### IV. Well Drilling Method

According to the present embodiment, there is provided a well drilling method in which the molded products for well drilling formed from the resin composition for well drilling according to the present embodiment are used. There are no particular limitations as to the well drilling method according to the present embodiment, provided that the well drilling method is one that uses the molded products for well drilling according to the present embodiment described previously. There is provided a well drilling method in which, by using the molded products for well drilling according to the present embodiment, even under harsh and diverse excavation conditions, such as great depth, the molded products will have high impact-resistance to resist damage during molding processes or transport, or due to contact or collision with the well wall surface or with various members during well drilling, and will moreover have excellent mechanical properties and heat resistance, and moreover can be easily removed after the end of the drilling operation if necessary, thus contributing to reductions in well drilling costs and to shorter processes.

For example, the well drilling method according to the present embodiment may be a method in which, specifically, a ball (ball sealer), a ball seat, or other downhole tool member employed as a molded product for well drilling according to the present embodiment is used to carry out perforation or fracturing of a downhole. Further, there is provided a well drilling method in which, through the use of a molded product for well drilling according to the present embodiment, for example, a downhole tool member will have high impact-resistance, as demonstrated by extremely high Izod impact strength (unnotched), so as to resist damage due to contact or collision with various members that are used in well drilling, and will moreover have excellent mechanical properties and heat resistance, thus producing the effects of reducing the cost required to drill a well, and of shorter processes. Further, there is provided a well drilling method in which, through the use of the downhole tool member according to the present embodiment, the downhole tool member can be easily removed, if necessary, through degradation of the degradable resin PGA by biodegradation, hydrolysis, or other method under diverse well environmental conditions, thus producing the effects of reducing the costs required to drill a well, and of shorter processes.

As the specific mode of the polyglycolic acid resin composition of the present invention described above, there is provided (1) a resin composition for well drilling, comprising a polyglycolic acid; and an acrylic rubber core-shell polymer having an acrylic rubber as a core layer, and a vinyl (co)polymer as a shell layer, wherein a melt viscosity of the polyglycolic acid is from 450 to 1600 Pa·s when measured at a temperature of 270° C. and a shear rate of 122 sec⁻¹, and an average inter-particle distance of the acrylic rubber core-shell polymer dispersed in the polyglycolic acid is from 0.2 to 2.5 μm.

According to the present embodiment, as specific modes of the resin composition for well drilling, there are provided the resin compositions for well drilling of (2) and (3) below.

(2) The resin composition for well drilling of (1), comprising from 60 to 98 mass % of the polyglycolic acid and from 2 to 40 mass % of the acrylic rubber core-shell polymer, where the total of the polyglycolic acid and the acrylic rubber core-shell polymer equals 100 mass %.
(3) The resin composition for well drilling of (1) or (2), comprising from 0 to 25 parts by mass of a glycidyl methacrylate-ethylene copolymer, where the total of the polyglycolic acid and the acrylic rubber core-shell polymer equals 100 parts by mass.

Further, according to the present embodiment, there is provided (4) a molded product for well drilling formed from the resin composition for well drilling of any of the preceding modes (1) to (3), and, as specific modes of this molded product for well drilling, the molded products for well drilling of (5) to (7) below.

(5) The molded product for well drilling of (4), wherein the molded product for well drilling is a melt molded product.
(6) The molded product for well drilling of (4) or (5), wherein the molded product for well drilling is a downhole tool member.
(7) The molded product for well drilling of (6), wherein the molded product for well drilling is a downhole tool member selected from the group consisting of balls, ball seats, mandrels, slips, wedges, and rings.

Additionally, according to the present embodiment, there is provided (8) a downhole tool member formed from the resin composition for well drilling of any of the aforementioned modes (1) to (3), and (9) the downhole tool member of (8), selected from the group consisting of balls, ball seats, mandrels, slips, wedges, and rings.

Further, according to the present embodiment there is provided (10) a well drilling method in which the molded product for well drilling of any of modes (4) to (7) is used.

The present embodiment has the advantageous effect that, by employing a resin composition for well drilling which contains polyglycolic acid, and an acrylic rubber core-shell polymer having an acrylic rubber as a core layer and a vinyl (co)polymer as a shell layer, there can be provided a resin composition for well drilling which, despite harsh and diverse excavation conditions, such as greater depths, encountered in hydrocarbon resource recovery, has high impact-resistance to resist damage during molding processes or transport, or due to contact or collision with various members during well drilling, and which moreover has excellent mechanical properties and heat resistance, and can be easily removed after the end of the drilling process if necessary, thus contributing to reductions in well drilling costs and shorter processes.

Additionally, the present embodiment has the advantageous effect that, by adopting a molded product for well drilling or a downhole tool member formed from the aforementioned resin composition for well drilling, and particularly a downhole tool member selected from the group consisting of balls, ball seats, mandrels, slips, wedges, and rings, there is provided a resin composition for well drilling which, despite harsh and diverse excavation conditions, such as greater depths, encountered in hydrocarbon resource recovery, has high impact-resistance to resist damage during molding processes or transport, or due to contact or collision with various members during well drilling, and which moreover has excellent mechanical properties and heat resistance, and can be easily removed after the end of the drilling process if necessary, thus contributing to reductions in well drilling costs and shorter processes.

Further, the present embodiment has the advantageous effect that by adopting a well drilling method that uses the aforementioned molded product for well drilling, there is provided a well drilling method by which, even under harsh and diverse excavation conditions, such as greater depths, encountered in hydrocarbon resource recovery, the molded product for well drilling will have high impact-resistance to resist damage during molding processes or transport, or due to contact or collision with various members during well drilling, and will moreover have excellent mechanical properties and heat resistance, and can be easily removed after the end of the drilling process if necessary, thus contributing to reductions in well drilling costs and shorter processes.

### EXAMPLES

The present invention will be described further in detail through Examples and Comparative Examples below, but the present invention is not limited to these Examples. In the following description, resin compositions for well drilling which are one embodiment of the polyglycolic acid resin composition according to the present invention are cited as examples. Measurement methods of the physical properties and characteristics of the resin compositions for well drilling in the Examples and the Comparative Examples are as follows.

### Melt Viscosity

The melt viscosity of the PGA contained in the resin compositions for well drilling was measured using a capillograph (CAPILLO 1A manufactured by Toyo Seiki Seisaku-sho, Ltd.) at a temperature of 270° C. and a shear rate of 122 sec⁻¹ (unit: Pa·s).

### Izod Impact Strength (Unnotched) and Izod Impact Strength (Notched)

The Izod impact strength (unnotched) of the resin compositions for well drilling was measured on an unnotched test piece at normal temperature, in accordance with ASTM D256 (corresponding to ISO 180), using a pendulum impact test machine (manufactured by Toyo Seiki Seisaku-sho, Ltd., hammer mass 120 kg), and calculating the Izod impact strength (unnotched) (average value of n=5. Unit: J/m). The Izod impact strength (notched) was calculated by taking measurements of notched test pieces at normal temperature, likewise in accordance with ASTM D256, using a pendulum type impact strength (manufactured by Ueshima Seisakusho Co., Ltd., hammer mass 40 kg).

### Flexural Strength (Maximum Point Stress)

The flexural strength (maximum point stress) of the resin compositions for well drilling was calculated from measurements of maximum point stress when the test piece ruptured, taken from a stress-deflection curve obtained by carrying out bending tests at normal temperature in accordance with JIS K7171, using a 2t Autograph AG-2000E manufactured by Shimadzu Corporation (average value of n=5. Unit: MPa).

### Heat Resistance

The heat resistance of the resin compositions for well drilling was verified by the following method. Specifically, an unnotched test piece prepared in accordance with the method described previously in the description of the Izod impact strength (unnotched) test method, was left to stand for a prescribed time (1 hour, 4 hours, and 8 hours) in an oven adjusted to a temperature of 170° C., after which time the Izod impact strength (unnotched) of the unnotched test piece was measured, and the maintenance rate (unit: %) with respect to the Izod impact strength (unnotched) of the unnotched test piece prior to being left to stand in the oven was calculated.

### Average Inter-Particle Distance

The average inter-particle distance of the acrylic rubber core-shell polymer dispersed within the polyglycolic acid in the resin compositions for well drilling was verified by the following method. Specifically, an injection-molded piece of a sample (a resin composition for well drilling) was cut out with a glass knife, and figuring was performed with a diamond knife. After an Ar ion etching treatment of the surface, a conductivity treatment was carried out. The surface obtained thereby was observed using a scanning electron microscope (trade name “SU8220” manufactured by Hitachi High-Technologies Corporation, hereinafter abbreviated as “SEM”) at an acceleration voltage of 1 kV, from the secondary electron image (signal: SE).

In an SEM image having a 5000×-magnified visual field, the acrylic rubber core-shell polymer particles dispersed within the polyglycolic acid were digitized. Next, using the digitized image, the distances between centroids of nearby particles were measured by an inter-centroid distance method for measuring dispersity using image analysis software (trade name “Azokun” manufactured by Asahi Kasei Engineering Corporation), and the average value thereof was calculated as the average inter-particle distance. Agglomerated core-shell polymer particles were considered as single individual particles.

### (1) Impact-Resistance and Other Parameters

### Example 1

A resin composition for well drilling was obtained by mixing 96 mass % of PGA (manufactured by Kureha Corporation, melt viscosity 1000 Pa·s when measured at a temperature of 270° C. and a shear rate of 122 sec⁻¹, weight average molecular weight 219000) and 4 mass % of an acrylic rubber core-shell polymer which is an impact modifier (PARALOID (trade name) EXL-2314 manufactured by Rohm and Haas, average particle size 0.37 μm. Hereinafter also called “acrylic rubber core-shell polymer A”) (where the PGA and the acrylic rubber core-shell polymer A together total 100 mass %) for 5 minutes at a temperature of 230° C. using a 30 mmφ kneading extruder (2D30W2 manufactured by Toyo Seiki Seisaku-sho, Ltd.) having an L/D ratio of 30, and then using an injection molding machine to prepare samples for measurement of physical properties and characteristics. For the resulting resin composition for well drilling, measurement and calculation of the Izod impact strength (unnotched), the Izod impact strength (notched), and the flexural strength (maximum point stress) (hereafter sometimes referred to collectively as “impact-resistance and other parameters”) was carried out. The results, together with the formulation of the resin composition for well drilling, are shown in Table 1. The state of dispersion of the acrylic rubber core-shell polymer in the PGA in the resin composition for well drilling obtained thereby was examined using an SEM, and it was found that the polymer was uniformly dispersed in the form of primary particles. The average inter-particle distance of the acrylic rubber core-shell polymer dispersed in the PGA was calculated from an SEM image having a 5000×-magnified visual field, and the results are shown in Table. 1. Note that the “acrylic rubber core-shell polymer A” is denoted simply as “A” in Table 1 and subsequently.

### Example 2

A resin composition for well drilling was obtained in the same manner as in Example 1, except that the formulation of the resin composition for well drilling was changed to 92 mass % of PGA and 8 mass % of the acrylic rubber core-shell polymer A (where the PGA and the acrylic rubber core-shell polymer A together total 100 mass %). Measurement and calculation of the impact-resistance and other parameters were carried out on the resin composition for well drilling so obtained. The results, together with the formulation of the resin composition for well drilling, are shown in Table 1.

### Example 3

A resin composition for well drilling was obtained in the same manner as in Example 1, except that the formulation of the resin composition for well drilling was changed to 90 mass % of PGA and 10 mass % of the acrylic rubber core-shell polymer A (where the PGA and the acrylic rubber core-shell polymer A together total 100 mass %). Measurement and calculation of the impact-resistance and other parameters were carried out on the resin composition for well drilling so obtained. The results, together with the formulation of the resin composition for well drilling, are shown in Table 1. The state of dispersion of the acrylic rubber core-shell polymer in the PGA in the resin composition for well drilling obtained thereby was examined in the same manner as in Example 1, and was found to be uniformly dispersed in the form of primary particles. The average inter-particle distance of the acrylic rubber core-shell polymer dispersed in the PGA was calculated in the same manner as in Example 1; the results are shown in Table 1.

### Example 4

A resin composition for well drilling was obtained in the same manner as in Example 1, except that the formulation of the resin composition for well drilling was changed to 87 mass % of PGA and 13 mass % of the acrylic rubber core-shell polymer A (where the PGA and the acrylic rubber core-shell polymer A together total 100 mass %). Measurement and calculation of the impact-resistance and other parameters were carried out on the resin composition for well drilling so obtained. The results, together with the formulation of the resin composition for well drilling, are shown in Table 1.

### Example 5

A resin composition for well drilling was obtained in the same manner as in Example 1, except that the formulation of the resin composition for well drilling was changed to 80 mass % of PGA and 20 mass % of the acrylic rubber core-shell polymer A (where the PGA and the acrylic rubber core-shell polymer A together total 100 mass %). Measurement and calculation of the impact-resistance and other parameters were carried out on the resin composition for well drilling so obtained. The results, together with the formulation of the resin composition for well drilling, are shown in Table 1.

### Example 6

An acid resin composition for well drilling was obtained in the same manner as in Example 1, except that the formulation of the resin composition for well drilling was changed to 75 mass % of PGA and 25 mass % of the acrylic rubber core-shell polymer A (where the PGA and the acrylic rubber core-shell polymer A together total 100 mass %). Measurement and calculation of the impact-resistance and other parameters were carried out on the resin composition for well drilling so obtained. The results, together with the formulation of the resin composition for well drilling, are shown in Table 1.

### Example 7

A resin composition for well drilling was obtained in the same manner as in Example 1, except that an acrylic core-shell polymer (PARALOID (trade name) EXL-2313 manufactured by Rohm and Haas. Hereinafter also called “acrylic core-shell polymer B”) was used in place of the acrylic rubber core-shell polymer A (where the PGA and the acrylic rubber core-shell polymer B together total 100 mass %). Measurement and calculation of the impact-resistance and other parameters were carried out on the resin composition for well drilling so obtained. The results, together with the formulation of the resin composition for well drilling, are shown in Table 1. Note that the “acrylic core-shell polymer B” is denoted simply as “B” in Table 1.

### Example 8

A resin composition for well drilling was obtained in the same manner as in Example 1, except that an acrylic core-shell polymer (PARALOID (trade name) EXL-2315 manufactured by Rohm and Haas. Hereinafter also called “acrylic core-shell polymer C”) was used in place of the acrylic rubber core-shell polymer A (where the PGA and the acrylic rubber core-shell polymer C together total 100 mass %). Measurement and calculation of the impact-resistance and other parameters were carried out on the resin composition for well drilling so obtained. The results, together with the formulation of the resin composition for well drilling, are shown in Table 1. Note that the “acrylic core-shell polymer C” is denoted simply as “C” in Table 1.

### Example 9

A resin composition for well drilling was prepared in the same manner as in Example 1, by mixing PGA, the acrylic rubber core-shell polymer A, and a glycidyl methacrylate-ethylene copolymer (BONDFAST (trade name) 2B manufactured by Sumitomo Chemical) in prescribed amounts such that the composition contained 1 part by mass of the glycidyl methacrylate-ethylene copolymer per 100 parts by mass of the resin composition for well drilling of Example 1. The glycidyl methacrylate-ethylene copolymer used was a glycidyl methacrylate-ethylene-vinyl acetate ternary copolymer. Measurement and calculation of the impact-resistance and other parameters were carried out on the resin composition for well drilling so obtained. The results, together with the formulation of the resin composition for well drilling, are shown in Table 1.

### Example 10

A resin composition for well drilling was prepared in the same manner as in Example 1, by mixing PGA, the acrylic rubber core-shell polymer A, and a glycidyl methacrylate-ethylene copolymer (BONDFAST (trade name) 2B manufactured by Sumitomo Chemical) in prescribed amounts such that the composition contained 5 parts by mass of the glycidyl methacrylate-ethylene copolymer per 100 parts by mass of the resin composition for well drilling of Example 1. The glycidyl methacrylate-ethylene copolymer used was a glycidyl methacrylate-ethylene-vinyl acetate ternary copolymer. Measurement and calculation of the impact-resistance and other parameters were carried out on the resin composition for well drilling so obtained. The results, together with the formulation of the resin composition for well drilling, are shown in Table 1.

### Example 11

A resin composition for well drilling was prepared in the same manner as in Example 1, by mixing PGA, the acrylic rubber core-shell polymer A, and a glycidyl methacrylate-ethylene copolymer (BONDFAST (trade name) 2B manufactured by Sumitomo Chemical) in prescribed amounts such that the composition contained 20 parts by mass of the glycidyl methacrylate-ethylene copolymer per 100 parts by mass of the resin composition for well drilling of Example 1. The glycidyl methacrylate-ethylene copolymer used was a glycidyl methacrylate-ethylene-vinyl acetate ternary copolymer. Measurement and calculation of the impact-resistance and other parameters were carried out on the resin composition for well drilling so obtained. The results, together with the formulation of the resin composition for well drilling, are shown in Table 1.

### Comparative Example 1

A PGA resin composition was obtained in the same manner as in Example 1, except that the formulation was changed to one containing 100 mass % of PGA (containing no acrylic rubber core-shell polymer). Measurement and calculation of the impact-resistance and other parameters were carried out on the PGA resin composition so obtained. The results, together with the formulation, are shown in Table 1.

### Comparative Example 2

A PGA resin composition was obtained in the same manner as in Example 1, except that the formulation was changed to one in which the melt viscosity of the PGA was 1 Pa·s (weight average molecular weight 63000). Measurement and calculation of the impact-resistance and other parameters were carried out on the PGA resin composition so obtained. The results, together with the formulation, are shown in Table 1.

### Comparative Example 3

A PGA resin composition was obtained in the same manner as in Example 1, except that the formulation was changed to one in which the melt viscosity of the PGA was 230 Pa·s (weight average molecular weight 155000). Measurement and calculation of the impact-resistance and other parameters were carried out on the PGA resin composition so obtained. The results, together with the formulation, are shown in Table 1. When the state of dispersion of the acrylic rubber core-shell polymer in the PGA in the resin composition for well drilling obtained thereby was examined in the same manner as in Example 1, it was found that aggregates of secondary or higher particles were present. The average inter-particle distance of the acrylic rubber core-shell polymer dispersed in the PGA was calculated in the same manner as in Example 1; the results are shown in Table 1.

### Comparative Example 4

A PGA resin composition was obtained in the same manner as in Example 1, except that the formulation was changed to one containing 99 mass % of PGA and 1 mass % of acrylic rubber core-shell polymer A. Measurement and calculation of the impact-resistance and other parameters were carried out on the PGA resin composition so obtained. The results, together with the formulation, are shown in Table 1. The state of dispersion of the acrylic rubber core-shell polymer in the PGA in the resin composition for well drilling obtained thereby was examined using an SEM, and it was found that the polymer was uniformly dispersed in the form of primary particles. The average inter-particle distance of the acrylic rubber core-shell polymer dispersed in the PGA was calculated from an SEM image having a 5000×-magnified visual field, and the results are shown in Table 1.

### Comparative Example 5

A resin composition for well drilling was obtained by mixing 96 mass % of PGA (manufactured by Kureha Corporation, melt viscosity 1000 Pa·s when measured at a temperature of 270° C. and a shear rate of 122 sec⁻¹, weight average molecular weight 219000) and 4 mass % of the acrylic rubber core-shell polymer A (where the PGA and the acrylic rubber core-shell polymer A together total 100 mass %) for 3 minutes at a temperature of 230° C. using a 20 mmφ kneading extruder (2D25S manufactured by Toyo Seiki Seisaku-sho, Ltd.) having an L/D ratio of 25, and then using an injection molding machine to prepare samples for measurement of physical properties and characteristics. Measurement and calculation of the impact-resistance and other parameters were carried out on the resin composition for well drilling so obtained. The results, together with the formulation, are shown in Table 1. When the state of dispersion of the acrylic rubber core-shell polymer in the PGA in the resin composition for well drilling obtained thereby was examined in the same manner as in Example 1, it was found that aggregates of secondary or higher particles were present. The average inter-particle distance of the acrylic rubber core-shell polymer dispersed in the PGA was calculated in the same manner as in Example 1; the results are shown in Table 1.

### Evaluation

The results of the above Examples 1 to 11 and Comparative Examples 1 to 5 were evaluated by the following method. Specifically, for the above Examples 1 to 11 and Comparative Examples 1 to 5, it was evaluated whether the Izod impact strength (unnotched), the Izod impact strength (notched), and the flexural strength levels were satisfactory or not, on the basis of the respective decision criteria given below. For the evaluation, compositions that were decided to be satisfactory in all of the parameters of Izod impact strength (unnotched), Izod impact strength (notched), and flexural strength were evaluated as “Good,” and those decided to be unsatisfactory in any of the parameters were evaluated as “Poor.” The results are shown in Table 1.

### Decision Criteria

Izod impact strength (unnotched): if 1100 J/m or greater, it was decided that “Izod impact strength (unnotched) is satisfactory.”
Izod impact strength (notched): if 50 J/m or greater, it was decided that “Izod impact strength (notched) is satisfactory.”
Flexural strength” if 100 MPa or greater, it was decided that “flexural strength is satisfactory.”

TABLE 1

| | | | | | Added amount | | | | | | |
|---|---|---|---|---|---|---|---|---|---|---|---|
| | | | | | of glycidyl | | | | | Average | |
| | PGA | | | | methacrylate- | Melt- | Izod impact | | | inter-particle | |
| | Melt | | | | ethylene | kneading | strength | | Flexural | distance | |
| | viscosity | PGA | Impact modifier | | copolymer | method | Unnotched | Notched | strength | (inter-centroid) | |
| Items | (Pa · s) | (mass %) | Name | (mass %) | (parts by mass) | L/D | (J/m) | (J/m) | (MPa) | (μm) | Evaluation |
| Example 1 | 1000 | 96 | A | 4 | — | 30 | 1625 | 77 | 172 | 1.34 | Good |
| Example 2 | 1000 | 92 | A | 8 | — | 30 | 2278 | 109 | 156 | — | Good |
| Example 3 | 1000 | 90 | A | 10 | — | 30 | 2429 | 131 | 151 | 0.97 | Good |
| Example 4 | 1000 | 87 | A | 13 | — | 30 | 2615 | 143 | 144 | — | Good |
| Example 5 | 1000 | 80 | A | 20 | — | 30 | 3615 | 190 | 124 | _ | Good |
| Example 6 | 1000 | 75 | A | 25 | — | 30 | 3923 | 218 | 106 | — | Good |
| Example 7 | 1000 | 96 | B | 4 | — | 30 | 1131 | 65 | 175 | — | Good |
| Example 8 | 1000 | 96 | C | 4 | — | 30 | 1183 | 62 | 176 | — | Good |
| Example 9 | 1000 | 96 | A | 4 | 1 | 30 | 1399 | 87 | 165 | — | Good |
| Example 10 | 1000 | 96 | A | 4 | 5 | 30 | 2171 | 136 | 160 | — | Good |
| Example 11 | 1000 | 96 | A | 4 | 20 | 30 | 2223 | 179 | 104 | — | Good |
| Comparative | 1000 | 100 | — | — | — | 30 | 798 | 35 | 197 | — | Poor |
| Example 1 | | | | | | | | | | | |
| Comparative | 1 | 96 | A | 4 | — | 30 | 47 | 14 | 69 | — | Poor |
| Example 2 | | | | | | | | | | | |
| Comparative | 230 | 96 | A | 4 | — | 30 | 530 | 43 | 167 | 1.99 | Poor |
| Example 3 | | | | | | | | | | | |
| Comparative | 1000 | 99 | A | 1 | — | 30 | 680 | 56 | 184 | 3.06 | Poor |
| Example 4 | | | | | | | | | | | |
| Comparative | 1000 | 96 | A | 4 | — | 25 | 573 | 55 | 187 | 2.77 | Poor |
| Example 5 | | | | | | | | | | | |

From Table 1, the resin compositions for well drilling of Examples 1 to 11, which contained PGA and the acrylic rubber core-shell polymer, were judged to have very high impact-resistance due to an Izod impact strength (unnotched) greater than 1100 J/m and an Izod impact strength (notched) greater than 60 J/m, and moreover had excellent mechanical properties due to a flexural strength (maximum point stress) greater than 100 MPa.

In particular, the resin compositions for well drilling of Examples 1 to 6, which contained PGA and an acrylic rubber core-shell polymer in which the core layer is acrylic rubber and the shell layer is epoxy group-having vinyl (co)polymers, were judged to have particularly high impact-resistance and excellent mechanical properties, due to adjustment of the acrylic rubber core-shell polymer content. Additionally, the resin compositions for well drilling of Examples 9 to 11, which contained a glycidyl methacrylate-ethylene copolymer in addition to the acrylic rubber core-shell polymer, were judged to similarly have very high impact-resistance and excellent mechanical properties.

In contrast to this, while the PGA resin composition of Comparative Example 1, which did not contain an acrylic rubber core-shell polymer, could be said to have excellent mechanical properties due to a flexural strength (maximum point stress) greater than 100 MPa, the composition was found to have low impact-resistance, due to an Izod impact strength (unnotched) less than 900 J/m and an Izod impact strength (notched) less than 50 J/m.

The PGA resin composition of Comparative Example 2, in which the PGA melt viscosity was very low, was found to have low impact-resistance and poor mechanical properties, due to an Izod impact strength (unnotched) less than 900 J/m and an Izod impact strength (notched) less than 50 J/m, as well as a flexural strength (maximum point stress) of 100 MPa or less.

Further, while the PGA resin composition of Comparative Example 3, in which the PGA melt viscosity was low, could be said to have excellent mechanical properties due to a flexural strength (maximum point stress) greater than 100 MPa, the composition was found to have low impact-resistance, due to an Izod impact strength (unnotched) less than 900 J/m and an Izod impact strength (notched) less than 50 J/m.

Further, the PGA resin composition of Comparative Example 4, in which the added amount of the acrylic rubber core-shell polymer A impact modifier was very small, could be said to have excellent mechanical properties due to a flexural strength (maximum point stress) greater than 100 MPa. However, due to an Izod impact strength (unnotched) less than 900 J/m, the impact-resistance was judged to be low, despite an Izod impact strength (notched) of 50 J/m or greater.

Further, the PGA resin composition of Comparative Example 5, in which the LD ratio of the kneading extruder was 25, could be said to have excellent mechanical properties due to a flexural strength (maximum point stress) greater than 100 MPa. However, due to an Izod impact strength (unnotched) less than 900, the impact-resistance was judged to be low, despite an Izod impact strength (notched) of 50 J/m or greater. This is attributed to poor dispersion of the acrylic rubber core-shell polymer impact modifier, due to the LD=25 low-shear kneading extruder.

### (2) Heat Resistance

### Example 12

The resin composition for well drilling of Example 1 containing the acrylic rubber core-shell polymer A (also called “resin composition for well drilling of Example 12” hereinafter) was measured for the Izod impact strength (unnotched) and the maintenance rate (unit: %) was calculated in order to determine the heat resistance of the resin composition for well drilling. The Izod impact strength (unnotched) and maintenance rate (unit: %) observed with each duration for which the composition was left to stand in an oven adjusted to a temperature of 170° C. (also called “treatment duration” hereinafter) are shown in Table 2.

### Example 13

Heat resistance was measured in the same manner as in Example 12 for the resin composition for well drilling of Example 10 which contained the acrylic rubber core-shell polymer A and a glycidyl methacrylate-ethylene copolymer (also called “resin composition for well drilling of Example 13” hereinafter). The Izod impact strength (unnotched) and maintenance rate (unit: %) observed with each treatment duration are shown in Table 2.

### Comparative Example 6

A resin composition containing PGA (also called “resin composition of Comparative Example 6” hereinafter) was obtained in the same manner as in Example 12, except that a butadiene core-shell polymer (PARALOID (trade name) EXL-2650J manufactured by Rohm and Haas) was used in place of the acrylic rubber core-shell polymer (where the PGA and the butadiene core-shell polymer together total 100 mass %). The butadiene core-shell polymer was a core-shell polymer having a butadiene/styrene copolymer as the core layer, and a methyl methacrylate polymer as the shell layer, and lacked an acrylic rubber core layer, and therefore does not fall into the category of an acrylic rubber core-shell polymer. The heat resistance of the PGA-containing resin composition so obtained was measured in the same manner as in Example 12. The Izod impact strength (unnotched) and maintenance rate (unit: %) observed with each treatment duration are shown in Table 2.

### Comparative Example 7

The heat resistance of the PGA resin composition of Comparative Example 1 (also called “resin composition of Comparative Example 7” hereinafter), which did not contain an acrylic rubber core-shell polymer, was measured in the same way as in Example 12. The Izod impact strength (unnotched) and maintenance rate (unit: %) observed with each treatment duration are shown in Table 2.

TABLE 2

| | | | | | | Comparative | | Comparative | |
|---|---|---|---|---|---|---|---|---|---|
| | | Example 12 | | Example 13 | | Example 6 | | Example 7 | |
| | | Impact modifier | | | | | | | |
| | | | | | | Butadiene core-shell | | | |
| | | Acrylic rubber core-shell polymer A | | | | polymer | | | |
| | | Content (mass %) | | | | | | | |
| | | 4 | | 4 | | 4 | | — | |
| | | Glycidyl methacrylate-ethylene copolymer (parts by mass/total of PGA + impact modifier (100 parts by mass)) | | | | | | | |
| | | — | | 5 | | — | | — | |
| | | Izod impact strength (Unnotched) | | | | | | | |
| | | Impact | Maintenance | Impact | Maintenance | Impact | Maintenance | Impact | Maintenance |
| | | strength | rate | strength | rate | strength | rate | strength | rate |
| | | (J/m) | (%) | (J/m) | (%) | (J/m) | (%) | (J/m) | (%) |
| Treatment duration | 0 | 1625 | 100 | 2171 | 100 | 1648 | 100 | 798 | 100 |
| at temperature of | 1 | 1372 | 84 | 2811 | 129 | 1292 | 78 | 343 | 43 |
| 170° C. (hours) | 4 | 1476 | 91 | 2860 | 132 | 400 | 24 | 343 | 43 |
| | 8 | 1340 | 82 | 2542 | 117 | 230 | 14 | 367 | 46 |

From Table 2, the resin compositions for well drilling of Examples 12 and 13, which contained PGA and the acrylic rubber core-shell polymer A were judged to have very high heat resistance, due to an Izod impact strength (unnotched) greater than 1100 J/m before being left to rest in an oven adjusted to a temperature of 170° C., and to an Izod impact strength (unnotched) maintenance rate greater than 80% even after being left to rest in the oven for 8 hours. In particular, the resin composition for well drilling of Example 13, which contained acrylic rubber core-shell polymer A and a glycidyl methacrylate-ethylene copolymer, was found to have an Izod impact strength (unnotched) greater than 2000 J/m before being left to rest in the oven, and an Izod impact strength (unnotched) maintenance rate greater than 110% even after being left to rest in the oven for 8 hours. Consequently, it was found that marked improvement in heat resistance can be achieved through the concomitant use of acrylic rubber core-shell polymer A and the glycidyl methacrylate-ethylene copolymer.

In contrast to this, the PGA-containing composition of Comparative Example 6, which contained a core-shell polymer which is a butadiene core-shell polymer not falling into the category of an acrylic rubber core-shell polymer, had an Izod impact strength (unnotched) greater than 1100 J/m before being left to rest in the oven, but when left to stand in the oven for 4 hours or 8 hours experienced a marked decline in the Izod impact strength (unnotched) maintenance rate to 24% or 14%; and particularly when left for 8 hours, had minimal Izod impact strength (unnotched) as compared with the PGA resin composition of Comparative Example 7 which did not contain an acrylic rubber core-shell polymer, and was therefore judged to lack excellent heat resistance. Additionally, the PGA resin composition of Comparative Example 7, which did not contain an acrylic rubber core-shell polymer, not only had an Izod impact strength (unnotched) less than 900 J/m before being left to rest in the oven, but after being left to rest in the oven for one hour, also had an Izod impact strength (unnotched) maintenance rate less than 50%, and an Izod impact strength (unnotched) less than 500 J/m, and was therefore judged to lack high impact-resistance, and to lack excellent heat resistance.

### INDUSTRIAL APPLICABILITY

By employing a polyglycolic acid resin composition which contains PGA, and an acrylic rubber core-shell polymer having an acrylic rubber as a core layer and a vinyl (co)polymer as a shell layer, the present invention can provides a polyglycolic acid resin composition which, despite harsh and diverse excavation conditions, such as greater depths, encountered in hydrocarbon resource recovery, has high impact-resistance to resist damage during molding processes or transport, or due to contact or collision with various members during well drilling, and which moreover has excellent mechanical properties and heat resistance, and can be easily removed after the end of the drilling process if necessary, thus contributing to reductions in well drilling costs and shorter processes; as well as a molded product for well drilling, such as a downhole tool member, and therefore the present invention has high industrial applicability.

The present invention can also provide a well drilling method using the molded product for well drilling, whereby there can be provided a well drilling method in which the molded product for well drilling has high impact-resistance to resist damage during molding processes or transport, or due to contact or collision with various members during well drilling, and moreover has excellent mechanical properties and heat resistance, and can be easily removed after the end of the drilling process if necessary, thus contributing to reductions in well drilling costs and shorter processes, and therefore has high industrial applicability.

1. A molded product for well drilling formed from a polyglycolic acid resin composition,
the polyglycolic acid resin composition comprising:
a polyglycolic acid; and
an acrylic rubber core-shell polymer having an acrylic rubber as a core layer, and a vinyl (co)polymer as a shell layer,
wherein a melt viscosity of the polyglycolic acid is from 450 to 1600 Pa·s when measured at a temperature of 270° C. and a shear rate of 122 sec⁻¹,
an average inter-particle distance of the acrylic rubber core-shell polymer dispersed in the polyglycolic acid is from 0.2 to 2.5 μm,
an Izod impact strength (unnotched) of the polyglycolic acid resin composition after being left to stand for 4 hours at a temperature of 170° C. is 70% or greater of that of the polyglycolic acid resin composition prior to being left to stand for 4 hours at the temperature of 170° C., the Izod impact strength being measured in accordance with ASTM D256, and
the molded product for well drilling is a downhole tool member.

2. The molded product for well drilling according to claim 1, wherein the polyglycolic acid resin composition further comprises from 60 to 98 mass % of the polyglycolic acid and from 2 to 40 mass % of the acrylic rubber core-shell polymer, where a total of the polyglycolic acid and the acrylic rubber core-shell polymer equals 100 mass %.

3. The molded product for well drilling according to claim 1, wherein the polyglycolic acid resin composition further comprises from 1 to 25 parts by mass of a glycidyl methacrylate-ethylene copolymer, where the total of the polyglycolic acid and the acrylic rubber core-shell polymer equals 100 parts by mass.

4. The molded product for well drilling according to claim 1, wherein the molded product for well drilling is a melt molded product.

5. The molded product for well drilling according to claim 1, wherein the downhole tool member is selected from the group consisting of balls, ball seats, mandrels, slips, wedges, and rings.

6. A well drilling method using the molded product for well drilling according to claim 1.
